(19) United States
(12) Patent Application Publication
(10) Pub. No.: US 2018/0079006 A1
(43) Pub. Date: Mar. 22, 2018

(54) HEAT-TREATING METHOD FOR COMPACT, AND DUST CORE

(71) Applicant: Sumitomo Electric Sintered Alloy, Ltd., Takahashi-shi (JP)

(72) Inventors: Naoto Igarashi, Itami-shi (JP); Hidehisa Hirato, Itami-shi (JP)

(21) Appl. No.: 15/554,286

(22) PCT Filed: Mar. 14, 2016
(86) PCT No.: PCT/JP2016/057897

§ 371 Date: Aug. 29, 2017

(30) Foreign Application Priority Data
Mar. 27, 2015 (JP) 2015-067697

(51) Int. Cl. B22F 3/24; B22F 3/16; H01F 1/24; F27B 9/10

(52) U.S. Cl. CPC B22F 3/24; B22F 3/16; H01F 1/24; B22F 2304/10; B22F 2003/248; B22F 2301/35; F27B 9/10

(57) ABSTRACT

A heat-treating method for compact includes a compacting step of forming a compact by compacting a soft magnetic powder together with a compacting assistant, the soft magnetic powder being a collection of coated particles that are soft magnetic metal particles having a surface coated with an insulation coating, and a heat-treatment step of heat-treating the compact, the heat-treatment step including a first heat-treatment substep of performing heat treatment at a temperature in a decomposition temperature range of the compacting assistant, and a second heat-treatment substep of performing heat treatment at a temperature at which distortion of the soft magnetic powder in the compact is removed and which is higher than the temperature of the first heat treatment.

### TECHNICAL FIELD

The present invention relates to a heat-treating method for compact, and a dust core.

### BACKGROUND ART

Magnetic components include a magnetic core composed of a soft magnetic material such as iron, an alloy thereof, or an oxide such as ferrite; and a coil arranged on the magnetic core are used in various fields. Specific examples thereof include motors, transformers, reactors, and choke coils used for in-vehicle components mounted on vehicles such as hybrid automobiles and electric vehicles and power supply circuit components of various electric devices.

When magnetic components are used in alternating magnetic fields, energy loss that is referred to as iron loss (generally, the sum of hysteresis loss and eddy-current loss) occurs in magnetic cores. The eddy-current loss is proportional to the square of an operating frequency. Thus, when magnetic components are used at high frequencies such as several kilohertz, significant iron loss occurs. Dust cores are used for applications at such high operating frequencies, dust cores being formed by compacting soft magnetic powders that are collections of coated particles that are soft magnetic metal particles having outer peripheries coated with insulation coatings, the soft magnetic metal particles being composed of, for example, iron or an iron-based alloy. Because of the use of coated particles, insulation coatings of coated particles inhibit contact between soft magnetic metal particles, thus effectively reducing the eddy current loss (i.e., iron loss) in dust cores.

In the case of producing dust cores with coated particles, insulation coatings should be protected from damage by compacting. For example, Patent Literature 1 discloses the production of a compact by applying a lubricant (compacting assistant) to an inner periphery of a die, incorporating a lubricant (compacting assistant) into a powder of coated particles, and performing compacting. In particular, the incorporation of the compacting assistant into the coated particles can reduce the friction between the coated particles inside the compact to inhibit the damage of insulation coatings on the coated particles, thereby inhibiting an increase in the eddy current loss of a dust core attributable to the damage of the insulation coatings.

After the compacting, the dust core is subjected to heat treatment in order to remove distortion introduced into the soft magnetic powder included in the compact by the pressure of the compacting. This is because the distortion introduced into the soft magnetic powder increases the hysteresis loss of the dust core. This heat treatment can also remove the compacting assistant from the dust core in addition to the removal of the distortion. For the heat treatment to remove distortion, a carrier-type heat-treatment apparatus such as a mesh belt furnace described in, for example, Patent Literature 2 can be used. The mesh belt furnace includes a furnace main body including heaters, and a mesh belt that transports a compact. The mesh belt includes a mesh portion having a grid-net-like shape, the mesh portion being arranged on a surface of a conveyor portion formed of, for example, a steel band. This structure of the mesh belt enables an atmosphere in the furnace main body to be brought into contact with all peripheral surfaces of the compact, so that the compact is uniformly heat-treated.

Furthermore, in Patent Literature 2, a mesh stage is arranged on the mesh belt to convect the atmosphere between the mesh belt and the mesh stage, thereby easily removing the compacting assistant from a surface of the dust core during heating.

### CITATION LIST

### Patent Literature

PTL 1: Japanese Unexamined Patent Application Publication No. 2004-288983

PTL 2: Japanese Unexamined Patent Application Publication No. 2013-214664

### SUMMARY OF INVENTION

### Technical Problem

However, in a dust core having a complex shape obtained by a combination of a plate-like portion and a columnar portion, for example, a dust core having a box-like shape or a dust core having a flange portion, a compacting assistant is easily accumulated in an edge portion that is a boundary of planes in the course of heat treatment. The compacting assistant accumulated in the edge portion is oxidized by heat treatment to adhere to a surface of the dust core. The resulting oxide of the compacting assistant is carbonized by an increase in temperature and is left on the surface of the dust core in the form of a residue. Although the residue does not decrease the magnetic performance of the dust core itself, the residue can lead to a decrease in the performance of a magnetic component including the dust core. The residue formed by the carbonization of the compacting assistant is conductive. Thus, for example, in the case where a choke coil is produced with a dust core to which a residue adheres, the residue can be released from the dust core and can adhere to the coil to degrade the insulation performance of the coil.

The present invention has been accomplished in light of the foregoing circumstances. It is an object of the present invention to provide a heat-treating method for compact in such a manner that no residue is left on a surface of the compact. It is another object of the present invention to provide a dust core having no residue on a surface thereof.

### Solution to Problem

According to an aspect of the present invention, a heat-treating method for compact includes a compacting step of forming a compact by compacting a soft magnetic powder together with a compacting assistant, the soft magnetic powder being a collection of coated particles that are soft magnetic metal particles having a surface coated with an insulation coating, and a heat-treatment step of heat-treating the compact, the heat-treatment step including a first heat-treatment substep of performing heat treatment at a temperature in a decomposition temperature range of the compacting assistant, and a second heat-treatment substep of performing heat treatment at a temperature at which distortion of the soft magnetic powder in the compact is removed and which is higher than the temperature of the first heat treatment.

According to an aspect of the present invention, a dust core including a soft magnetic powder that is a collection of coated particles that are soft magnetic metal particles having a surface coated with an insulation coating includes an oxide coating arranged on all peripheral surfaces of the dust core, in which substantially no residue formed by carbonization of a compacting assistant adheres to a surface of the dust core.

### Advantageous Effects of Invention

According to the heat-treating method for compact, the compact can be heat-treated in such a manner that no residue is left on the surface.

### BRIEF DESCRIPTION OF DRAWINGS

FIG. 1 illustrates a temperature profile of a compact in a heat-treating method for compact according to an embodiment.

FIG. 2 is a schematic diagram of a carrier-type heat-treatment apparatus illustrated in an embodiment.

FIG. 3 is a schematic top view of a mesh belt of the carrier-type heat-treatment apparatus.

FIG. 4 is a graph depicting the results of thermogravimetry-differential scanning calorimetry of an internal lubricant described in test 1.

FIG. 5 is a graph depicting the results of thermogravimetry-differential scanning calorimetry of an internal lubricant described in test 2.

FIG. 6 is a schematic view of a compact having a flange portion and a compact having a rectangular frame-like shape.

FIG. 7 is an explanatory drawing illustrating the arrangement state of compacts and sampling sites in test 3.

FIG. 8 is a graph depicting the electric resistance of a dust core having a flange portion.

FIG. 9 is a graph depicting the electric resistance of a dust core having a rectangular frame-like shape.

FIG. 10 is a graph depicting the amount of surface C of a dust core having a flange portion.

FIG. 11 is a graph depicting the amount of surface C of a dust core having a rectangular frame-like shape.

FIG. 12 is a schematic view illustrating a dust core having a flange portion and a dust core having a rectangular frame-like shape.

### DESCRIPTION OF EMBODIMENTS

### Description of Embodiments of Invention

Embodiments of the present invention are first listed and explained.

The inventors have conducted studies on a mechanism to allow a residue to be left on a surface of a dust core during heat treatment of a compact and have found that in a carrier-type heat-treatment apparatus, a linear rate of temperature increase from the start of heating to a distortion removal temperature was problematic. When the rate of temperature increase is linear, a compacting assistant is carbonized on the surface of the compact before the compacting assistant is decomposed or evaporated to disappear from the surface of the compact during the heat treatment, leading to a state in which the residue (a carbonized material of the compacting assistant) is left on the surface of the dust core. In particular, in the cases of, for example, boxy dust cores and dust cores having a flange portion, the compacting assistant melted by heating is easily accumulated in edge portions that are boundaries of planes, thus leading to significant adhesion of the residue to the boundaries. In light of these points, the inventors have conceived that a two-stage heat treatment in which a compact is heated for a predetermined time at a temperature in the decomposition temperature range where a compacting assistant is decomposed and evaporated, and then the compact is heated at a distortion removal temperature higher than the decomposition temperature, is effective in producing a dust core free from a residue on a surface thereof. However, for the carrier-type heat-treatment apparatus that performs heat treatment with a compact transported, it is difficult to perform two-stage heat treatment. The reason for this is that because a furnace main body has a continuous inside portion, even if a low-temperature zone corresponding to the decomposition temperature range and a high-temperature zone corresponding to the distortion removal temperature are provided, heat in the high-temperature zone is transferred to the low-temperature zone to fail to maintain the temperature of the low-temperature zone in the decomposition temperature range. Based on these findings, the inventors have completed a heat-treating method for compact, and a dust core, as described below.

<1> A heat-treating method for compact according to an embodiment includes heat-treating a compact with a carrier-type heat-treatment apparatus, the compact being produced by compacting a soft magnetic powder together with a compacting assistant, the carrier-type heat-treatment apparatus including a furnace main body that includes heaters and a mesh belt that carries an object to be heat-treated into the inside of the furnace main body, the soft magnetic powder being a collection of coated particles that are soft magnetic metal particles having a surface coated with an insulation coating, to remove distortion introduced into the soft magnetic particles during the compacting. In this heat-treating method for compact, a low-temperature zone filled with an atmosphere in the furnace, the atmosphere being heated to a temperature in the decomposition temperature range of the compacting assistant, and a high-temperature zone filled with the atmosphere in the furnace, the atmosphere being heated to a distortion removal temperature, are provided by injecting a gas into the inside of the furnace main body. The compact is transported into the furnace main body and then heat-treated. A product subjected to final heat treatment is referred to as a “dust core”.

The injection of the gas into the inside of the furnace main body cools an hot atmosphere that flows from the high-temperature zone to the low-temperature zone to form the difference in temperature between the high-temperature zone and the low-temperature zone, so that two-stage heating can be performed even in the case of the carrier-type heat-treatment apparatus. According to the method, in which the two-stage heating is performed, for heat-treating a compact, after the compacting assistant on the surface of the compact is decomposed and evaporated in the low-temperature zone, the distortion of the resulting dust core can be removed in the high-temperature zone. The resulting heat-treated compact is a dust core having a surface to which substantially no residue adheres.

<2> A dust core according to an embodiment is formed by compacting a soft magnetic powder that is a collection of coated particles that are soft magnetic metal particles having a surface coated with an insulation coating, and heat-treating a compact containing a compacting assistant used in the compacting, the dust core including an oxide coating formed on all peripheral surfaces thereof by the heat treatment, and substantially no residue formed by carbonization of the compacting assistant adheres to a surface of the dust core.

The fact that substantially no residue adheres to the surface of the dust core can be visually identified. This is because the residue has a clearly different color from the oxide coating formed by the heat treatment. The residue is a carbonized material of the compacting assistant and composed of carbon (C) as a main component. Thus, the fact that substantially no residue adheres to the surface of the dust core can also be confirmed by confirming that the amount of surface C of the dust core is a specified value or less. The fact that substantially no residue adheres to the surface of the dust core indicates that the amount of surface C of the dust core is 50 at % (atomic percent) or less. The amount of surface C is an index to confirm that no residue adheres to the surface of the dust core, and is the percentage of C with respect to the total amount of atoms detected in the analysis of constituent elements on the surface.

Here, a residue formed by carbonization of a compacting assistant adheres to a surface of a dust core obtained by a conventional heat-treatment method. In the case where such a dust core is shipped, the residue that adheres to the surface of the dust core is removed. At the time of removal of the residue, an oxide coating formed by heat treatment is scratched, and the oxide coating is partially removed together with the residue. That is, a conventional dust core has a non-uniform portion (removal mark) of the oxide coating due to removal of the residue. In contrast, the dust core according to the embodiment is not subjected to a step of removing a residue; thus, the oxide coating is arranged on the surface.

The dust core whose all peripheral surfaces are covered with the oxide coating according to the embodiment does not easily rust. Thus, in this dust core, a decrease in the magnetic properties of the dust core due to rust is less likely to occur. Furthermore, because no residue adheres to the surface of the dust core, in the case of producing a magnetic component including the dust core, it is possible to inhibit a decrease in the magnetic properties of the magnetic component due to the residue.

<3> An example of the dust core according to the embodiment is a dust core having a structure with an edge portion.

In the case where a complex-shaped compact having an edge portion is heat-treated by a conventional heat-treatment method, a state in which a residue adheres to the edge portion is easily obtained. Thus, a conventional dust core has a removal mark of a residue in the edge portion. In contrast, in the case of the dust core according to the embodiment, even in the case of a structure having an edge portion, no removal mark is present in the edge portion.

<4> An example of the dust core according to the embodiment is a dust core including a columnar portion and a flange portion arranged on one end side of the columnar portion.

In the case where a compact including a columnar portion and a flange portion is subjected to heat treatment, when the flange portion is arranged at a lower section, a compacting assistant is easily accumulated at the boundary (edge portion) between the columnar portion and the flange portion. However, in the heat-treatment method according to the embodiment, the compact is held for a predetermined time at a temperature at which the compacting assistant is decomposed and evaporated; thus, the compacting assistant accumulated at the boundary (edge portion) is decomposed and evaporated.

### Details of Embodiments of Invention

Details of embodiments of the present invention will be described below with reference to the drawings. The present invention is not limited to these embodiments and is indicated by the appended claims. It is intended to include any modifications within the scope and meaning equivalent to the scope of the claims.

### First Embodiment

In a first embodiment, a heat-treating method for compact with a carrier-type heat-treatment apparatus including a furnace main body that includes heaters and a mesh belt that transports an object to be heat-treated into the inside of the furnace main body will be described. Prior to the description of the heat-treatment method, a compact to be heat-treated will be described.

### <<Compact to be Heat-Treated>>

The compact to be heat-treated is produced by compacting a soft magnetic powder together with a compacting assistant, the soft magnetic powder being a collection of coated particles that are soft magnetic metal particles having a surface coated with an insulation coating. Examples of the compacting assistant include (1) an internal lubricant that is mixed with the soft magnetic powder to inhibit the damage of the insulation coating; (2) a binder that is mixed with the soft magnetic powder; and (3) an external lubricant that is applied or sprayed onto the inner periphery of a die used for compacting.

### [Soft Magnetic Metal Particles]

A material of the soft magnetic metal particles preferably contains 50% or more by mass iron. Examples thereof include pure iron (Fe) and an iron alloy selected from the group consisting of Fe—Si-based alloys, Fe—Al-based alloys, Fe—N-based alloys, Fe—Ni-based alloys, Fe—C-based alloys, Fe—B-based alloys, Fe—Co-based alloys, Fe—P-based alloys, Fe—Ni—Co-based alloys, and Fe—Al—Si-based alloys. In particular, pure iron containing 99% or more by mass Fe is preferred in view of magnetic permeability and flux density.

The soft magnetic metal particles preferably have an average particle size d of 10 μm or more and 300 μm or less. An average particle size d of 10 μm or more results in good flowability and inhibition of an increase in the hysteresis loss of a dust core. An average particle size d of 300 μm or less results in an effective reduction in the eddy current loss of the dust core. In particular, at an average particle size d of 50 μm or more, the effect of reducing the hysteresis loss is easily provided, and the powder is easily handled. The average particle size d refers to 50% particle size (mass), which indicates, in the histogram of the particle size, the size of particles where the sum of the masses of the smaller particles accounts for 50% of the total mass.

### [Insulation Coating]

The insulation coating can be composed of a metal oxide, a metal nitride, a metal carbide, or the like, for example, an oxide, a nitride, or a carbide of one or more metal elements selected from Fe, Al, Ca, Mn, Zn, Mg, V, Cr, Y, Ba, Sr, rare-earth elements (excluding Y), and so forth. The insulation coating may also be composed of, for example, one or more compounds selected from phosphorus compounds, silicon compounds (such as silicone resins), zirconium compounds, and aluminum compounds. The insulation coating may also be composed of a metal salt compound, such as a metal phosphate compound (typically, iron phosphate, manganese phosphate, zinc phosphate, calcium phosphate, or the like), a metal borate compound, a metal silicate compound, a metal titanate compound, or the like.

The insulation coating preferably has a thickness of 10 nm or more and 1 μm or less. A thickness of 10 nm or more can result in a good insulation between the soft magnetic metal particles. At a thickness of 1 μm or less, the presence of the insulation coating can inhibit a decrease in the soft magnetic powder content of the dust core.

### [Compacting Assistant]

An example of the compacting assistant is an internal lubricant that is mixed with the soft magnetic powder. The incorporation of the internal lubricant into the soft magnetic powder inhibits the coated particles from being strongly rubbed against each other, so that the insulation coating of each of the coated particles is less likely to be damaged. The internal lubricant may be a liquid lubricant or a solid lubricant formed of a lubricant powder. In particular, the internal lubricant is preferably a solid lubricant in view of easy mixing with the soft magnetic powder. As the solid lubricant, a material that is easily and uniformly mixed with the soft magnetic powder, that is sufficiently deformable between the coated particles during the formation of a compact, and that is easily removed by heating for the heat treatment of the compact can be preferably used. For example, a metal soap, such as lithium stearate or zinc stearate, can be used as the solid lubricant. In addition, a fatty acid amide, such as lauramide, stearamide, or palmitamide, or a higher fatty acid, such as ethylenebis(stearamide), can be used.

With regard to a preferred amount of the internal lubricant mixed, the amount of the internal lubricant mixed with the coated soft magnetic powder is preferably 0.2% by mass to 0.8% by mass with respect to 100 of the coated soft magnetic powder. The solid lubricant constituting the internal lubricant is a solid lubricant having a maximum size of 50 μm or less. In the case of the solid lubricant of this size, the internal lubricant particles easily interpose between the coated soft magnetic particles to effectively reduce the friction between the coated soft magnetic particles, thus effectively preventing the damage of the insulation coating of the coated soft magnetism. In the case of mixing the internal lubricant with the coated soft magnetic powder, a double cone mixer or a V mixer may be used.

Another example of the compacting assistant is an external lubricant that is applied or sprayed onto an inner periphery of a die at the time of compacting. The use of the external lubricant reduces the friction between the inner periphery of the die and the outer periphery of the compact to inhibit the damage of the surface of the compact. The external lubricant may be in the form of a solid or liquid. The same material as the internal lubricant as described above can be used therefor.

### [Compacting]

A pressure at which a mixture of the soft magnetic powder and the compacting assistant is subjected to compacting is preferably 390 MPa or more and 1,500 MPa or less. A pressure of 390 MPa or more results in sufficient compaction of the soft magnetic powder to provide a high relative density of the compact. A pressure of 1,500 MPa or less results in the inhibition of the damage of the insulation coating due to contact between the coated particles included in the soft magnetic powder. The pressure is more preferably 700 MPa or more and 1,300 MPa or less.

The compact produced by the foregoing compacting is subjected to the heat-treating method for compact described below.

### <<Method for Heat-Treating Compact>>

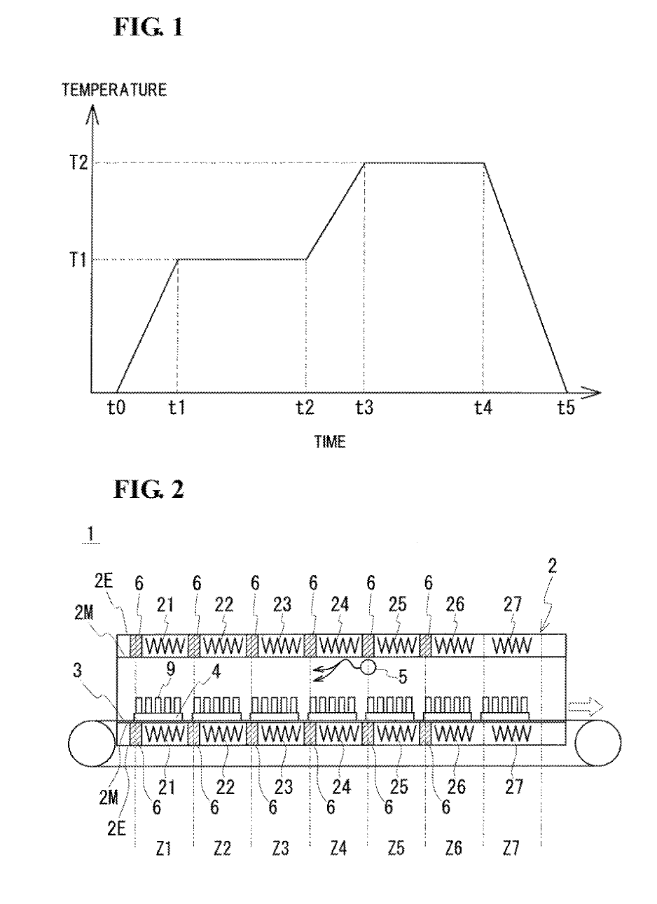

In the heat-treating method for compact according to the embodiment, two-stage heat treatment is performed with a carrier-type heat-treatment apparatus in order to perform heat treatment for the removal of distortion introduced into the compact at the time of the compacting. The two-stage heat treatment will be described with reference to a temperature profile in FIG. 1.

FIG. 1 illustrates a temperature profile of a compact in the heat-treating method for compact according to the embodiment. The horizontal axis represents time, and the vertical axis represents temperature. As illustrated in FIG. 1, in the heat-treating method for compact according to the embodiment, between the start (t0) and end (t5) of heating, the compact is held for a predetermined time (t1→t2) at a temperature (T1) in the decomposition temperature range of the compacting assistant in the compact, and then a second-stage heat treatment is performed in which the compact is held for a predetermined time (t3→t4) at a distortion removal temperature (T2) to remove the distortion introduced into the compact. In FIG. 1, t1→t2 corresponds to heating in the low-temperature zone of the carrier-type heat-treatment apparatus 1, and t3→t4 corresponds to heating in the high-temperature zone. Details of the temperature profile will be described below.

A heating rate (° C./min) when the compact is heated to the temperature (T1) in the decomposition temperature range can be appropriately selected. For example, the heating rate can be 2° C./min or more and 25° C./min or less. The heating rate is more preferably 3° C./min or more and 10° C./min or less. The time (t1) required to reach the decomposition temperature range varies, depending on the heating rate.

The decomposition temperature range of the compacting assistant varies, depending on the type of compacting assistant. Thus, a preliminary test with a compacting assistant used for a compact is performed to study [1] the decomposition temperature range of the compacting assistant and [2] the degrees of the decomposition and evaporation of the compacting assistant depending on the holding time of the compact in the decomposition temperature range. Based on the results, a first-stage heat treatment of the compact is performed. As described in test examples below, in the case of stearamide, the decomposition temperature range is about 171° C. to about 265° C. and the holding time in the decomposition temperature range is 30 minutes or more. The actual heat-treatment temperature is preferably a temperature slightly lower than a temperature at which the maximum amount of the compacting assistant decomposed is obtained (temperature at which the peak of an exothermic reaction is observed).

The heating rate (° C./min) when the compact is heated to the distortion removal temperature after the end (t2) of the first-stage heat treatment can be appropriately selected. For example, the heating rate is 2° C./min or more and 25° C./min or less. The heating rate is more preferably 5° C./min or more and 15° C./min or less. The time (t3) required to reach the distortion removal temperature varies, depending on the heating rate.

The distortion removal temperature (T2) and its holding time to remove the distortion introduced into the soft magnetic metal particles of the compact vary, depending on the type of soft magnetic metal particle. Thus, the distortion removal temperature and the holding time corresponding to the type of soft magnetic metal particle are studied in advance, and the second-stage heat treatment of the compact is performed on the basis of the distortion removal temperature and the holding time. For example, in the case of pure iron, the compact may be held at 300° C. or higher and 700° C. or lower for 5 minutes or more and 60 minutes or less.

After the end (t4) of the second-stage heat treatment, the cooling rate of the compact can be appropriately selected. For example, the cooling rate is 2° C./min or more and 50° C./min or less. The cooling rate is more preferably 10° C./min or more and 30° C./min or less. The cooling of the compact can be performed by air cooling.

When the two-stage heat treatment described above is performed, the compacting assistant bleeding from a surface of the compact can be removed by the first-stage heat treatment, and the distortion introduced into the soft magnetic metal particles of the compact can be removed by the second-stage heat treatment.

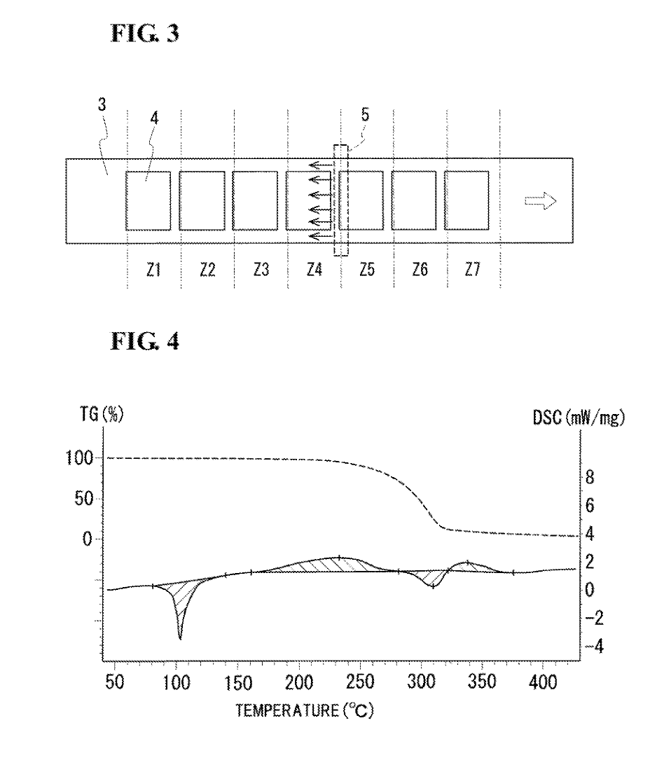

To perform the two-stage heat treatment with the carrier-type heat-treatment apparatus, in this embodiment, a gas is injected into the inside of the furnace main body of the carrier-type heat-treatment apparatus to form the low-temperature zone having a temperature (T1° C.) in the decomposition temperature range, the temperature being maintained by heating, and the high-temperature zone having the distortion removal temperature (T2° C.) maintained by heating, in the furnace main body. After the low-temperature zone and the high-temperature zone are formed in the furnace main body, the compact is heat-treated by being transported to the inside of the furnace main body. An example of the carrier-type heat-treatment apparatus will be described below with reference to FIGS. 2 and 3.

### <<Carrier-Type Heat-Treatment Apparatus>>

FIG. 2 is a schematic diagram of the carrier-type heat-treatment apparatus 1. FIG. 3 is a schematic top view of a mesh belt 3 included in the carrier-type heat-treatment apparatus 1. The carrier-type heat-treatment apparatus 1 illustrated in FIG. 2 includes a furnace main body 2 including heaters 21 to 27, and the mesh belt 3 that introduces compacts 9 into the furnace main body 2. Mesh stages 4 including depressions corresponding to the size of the compacts 9 are provided on the mesh belt 3. Thus, the compacts 9 can be heat-treated in one operation with the compacts 9 arranged. The mesh stages 4 have a raised bottom, thereby forming a predetermined gap between the mesh belt 3 and each mesh stage 4. This enables the production of the convection of an atmosphere in the gaps during the heat treatment of the compacts 9.

### [Furnace Main Body]

The furnace main body 2 includes an exterior 2E and a muffle (partition) 2M arranged therein. One end of the inside of the muffle 2M communicates with the other end. The upper half of the mesh belt 3 is arranged in the muffle (partition) 2M of the furnace main body 2. The heaters 21 to 27 aligned in the transportation direction of the compacts 9 are arranged between the exterior 2E and the muffle 2M and configured to heat the outer periphery of the muffle 2M.

The heaters 21 to 27 arranged in the furnace main body 2 can individually control the temperature. Thus, the heating temperature can be gradually increased from the entrance of the muffle 2M (upstream in the transportation direction) on the left side of the paper toward the exit of the muffle 2M (downstream in the transportation direction) on the right side of the paper. Furthermore, in this example, the space between the outer periphery of the muffle 2M and the inner periphery of the exterior 2E is partitioned with heat insulators 6, so that heat of one of two adjacent heaters is less likely to be transferred to the other heater. Thus, the temperatures of zones Z1 to Z7, described below, in the muffle 2M can be easily and individually controlled. In this example, the heat insulators 6 are located on the entrance side of the furnace main body 2 (on the left side of the paper) with respect to the heater 21, between the heaters 21 and 22, between the heaters 22 and 23, between the heaters 23 and 24, between the heaters 24 and 25, and between the heaters 25 and 26.

### [Mesh Belt and Mesh Stage]

As the mesh belt 3 and the mesh stages 4, a known components can be used. For example, those described in Patent Literature 2 (Japanese Unexamined Patent Application Publication No. 2013-214664) can be used.

### [Gas Pipe]

The inside of the furnace main body 2 is virtually divided into the seven zones Z1 to Z7 with the heaters 21 to 27 individually controlled. However, because the furnace main body 2 has a continuous inside portion, it is difficult to maintain the temperatures of the zones Z1 to 27 to desired temperatures. Thus, in this example, a gas pipe 5 is arranged over the mesh belt 3 (see also FIG. 3) and between the heaters 24 and 25. A gas is injected through the gas pipe 5. The gas pipe 5 has nozzles arranged on its peripheral wall and thus can uniformly inject the gas over the entire length of the mesh belt 3 in the width direction. The gas injection can produce a clear difference in temperature between the zones Z4 and Z5, thereby providing the low-temperature zone and the high-temperature zone in the furnace main body 2. This does not change the temperature in a curved manner but can facilitate a change in temperature in a linear manner between the low-temperature zone and the high-temperature zone not in a curved manner but in a linear manner. In the example illustrated, the low-temperature zone is provided in the zones Z2 to Z4 on the left side of the paper with respect to the gas pipe 5, and the high-temperature zone is provided in the zones Z6 and Z7 on the right side of the paper.

Amount of Gas Injected

The amount of the gas injected through the gas pipe 5 needs to be an amount capable of promoting the decomposition of the compacting assistant (described below) bleeding from the object to be heat-treated and capable of providing the difference in temperature between the low-temperature zone and the high-temperature zone. The use of an insufficient amount of the gas injected through the gas pipe 5 can fail to produce a clear difference in temperature between the low-temperature zone and the high-temperature zone. A preferred amount of the gas injected varies, depending on the temperature of the gas and the difference in temperature between the low-temperature zone and the high-temperature zone, and is thus difficult to clearly specify. For example, in the case of the gas having normal temperature, the amount of the gas injected is about 200 L (liters)/min or more and about 600 L/min or less.

Injection Direction of Gas

With respect to the injection direction of the gas through the gas pipe 5, the gas is preferably injected toward an upper portion of the low-temperature zone (entrance side in the transportation direction) rather than vertically downward. In this case, the gas is diffused in the entire low-temperature zone adjacent to the high-temperature zone; thus, the temperature of the low-temperature zone is easily maintained.

Temperature of Gas

The temperature of the gas is preferably a temperature equal to or lower than the decomposition temperature of the internal lubricant. In this case, it is possible to avoid an increase in the temperature of the low-temperature zone and maintain the low-temperature zone to a temperature in the decomposition temperature range. The temperature of the gas may also be appropriately changed. In this case, the low-temperature zone is easily maintained at a constant temperature by arranging a temperature sensor in the furnace main body 2, changing the temperature of the gas on the basis of detection results of the temperature sensor, and injecting the gas into the furnace main body 2.

Type of Gas

The type of the gas is not particularly limited. For example, air can be used as the gas, and an inert gas (for example, N₂ gas or Ar gas) can also be used. In the case where air is used as the gas, the gas need not be prepared separately, thus reducing the production costs of the compacts 9. In the case where the inert gas is used as the gas, although an inert gas storage facility is required, residues are less likely to be formed on surfaces of the compacts 9 during the heat treatment.

### [Others]

The carrier-type heat-treatment apparatus 1 of this example includes a structure that introduces a flow gas from the exit side toward the entrance side of the furnace main body 2. As the flow gas, air or an inert gas (for example, N₂ gas or Ar gas) can be used. In the case where air is used as the gas, the gas need not be prepared separately, thus reducing the production costs of the compacts 9. In the case where the inert gas is used as the gas, although an inert gas storage facility is required, residues are less likely to be formed on surfaces of the compacts 9 during the heat treatment.

<<Dust Core after Heat Treatment>>

The heat treatment of the compact with the carrier-type heat-treatment apparatus 1 that has been described above can provide a dust core having a uniform oxide coating formed on all peripheral surfaces of the dust core by the heat treatment, in which substantially no residue formed by carbonization of a compacting assistant adheres to a surface of the dust core.

The inner portion of the dust core after the heat treatment contains a trace amount of the compacting assistant used for compacting. The presence of the compacting assistant can be identified by, for example, energy-dispersive X-ray spectroscopy (EDX).

Whether the oxide coating is formed on all the peripheral surfaces or not can be visually identified because the surface color of the dust core after the heat treatment is clearly different from the surface color of the dust core before the heat treatment.

The fact that no residue formed by the carbonization of the compacting assistant adheres to a surface of the dust core can be visually identified. This is because the residue has a clearly different color from the oxide coating. As described in test examples described below, the fact that no residue adheres to a surface of the dust core can be identified by measuring the amount of carbon (C) on the surface of the dust core.

The dust core having no residue on a surface thereof can be suitably used for the production of a magnetic component such as choke coil. This is because when the magnetic component is assembled, a residue does not adhere to a coil or the like to impair the insulating properties of the coil.

The dust core that has been subjected to the two-stage heat treatment with the carrier-type heat-treatment apparatus 1 has improved DC magnetization characteristics (maximum relative magnetic permeability μₘ) and transverse rupture strength, compared with conventional dust cores that have been a single-stage heat treatment. Specifically, the dust core that has been subjected to the two-stage heat treatment has a maximum relative magnetic permeability μₘ of 580 or more, which is about 1.1 to about 1.2 times those of conventional dust cores. The transverse rupture strength of the dust core that has been subjected to the two-stage heat treatment is 70 MPa or more, which is about 1.5 to about 2 or more times those of conventional dust cores. The improvement of the characteristics is seemingly provided by removing almost all the compacting assistant from the inside of the dust core through the first-stage heat treatment. If the compacting assistant is left in the dust core, the second-stage heat treatment seems to form a carbonized material of the compacting assistant in the dust core, and the carbonized material seemingly degrades the magnetic and strength characteristics of the dust core.

Thus, a sufficient removal of the compacting assistant from the inside of the dust core through the first-stage heat treatment seemingly improves the characteristics of the dust core provided through the second-stage heat treatment.

### Test Examples

An optimal decomposition temperature and its holding time corresponding to the type of internal lubricant (compacting assistant) were determined. A dust core was actually produced by performing holding at the decomposition temperature for a predetermined time and then performing distortion removal. The presence of absence of a residue (carbonized material of the internal lubricant) on a surface of the dust core was checked.

### <<Test 1>>

To determine an optimal temperature at which the internal lubricant used for the formation of a compact is decomposed, the change of the internal lubricant was first studied when the internal lubricant was heated. The measured internal lubricant was stearamide, and the measurement was performed with thermogravimetry (TG)-differential scanning calorimetry (DSC). TG-DSC was used to simultaneously measure a change in the weight of the internal lubricant and a change in the thermal energy of the internal lubricant. The test conditions were described below. FIG. 4 illustrates the results.
Stearamide: granular form
Test starting temperature: 50° C.
Increase in temperature to 450° C. at 20° C./min
Air atmosphere at 50 mL/min

The graph in FIG. 4 illustrates the measurement results of TG-DSC. The horizontal axis represents the atmospheric temperature (° C.). The right vertical axis represents the heat flow (mW/mg). The left vertical axis represents the percentage by mass of a sample (%). The dotted line in the figure represents a change in the weight of stearamide. The solid line represents the heat flow. Regarding the heat flow, portions represented by a 45° (positive slope) hatch pattern indicate endothermic reactions, and portions represented by a 135° (negative slope) hatch pattern indicate exothermic reactions.

In order of increasing temperature, the melting of stearamide occurs in the first endothermic reaction, and the oxidative decomposition of stearamide occurs in the subsequent exothermic reaction. With the oxidative decomposition of stearamide, the weight of stearamide is rapidly reduced.

In the second endothermic reaction, the thermal decomposition (carbonization) of stearamide occurs. With this, the weight of stearamide is further reduced. In the second exothermic reaction, the combustion of stearamide occurs. With regard to the exothermic reaction among these reactions, the starting temperature at which the oxidative decomposition occurred was about 171° C., the end temperature was about 265° C., and the peak temperature was about 234° C.

In order not to allow a residue to adhere to a surface of the dust core, it is important to heat-treat the compact in a decomposition temperature range where the oxidative decomposition of stearamide occurs (i.e., the temperature range of the first exothermic reaction). That is, the temperature of the low-temperature zone used for the first-stage heat treatment of the compact is 171° C. or higher and 265° C. or lower. Here, because the use of a higher temperature starts to cause stearamide to be partially carbonized, the actual heat-treatment temperature (temperature of the low-temperature zone) of the compact is preferably a temperature slightly lower than the peak temperature. For example, the heat-treatment temperature of the compact is the starting temperature of the exothermic reaction+0.3 to 0.6×[the temperature range of the exothermic reaction]. In the case of stearamide in this example, 171° C.+0.3×(265° C.−171° C.) or higher and 171° C.+0.6×(265° C.−171° C.) or lower, i.e., about 199° C. or higher and about 227° C. or lower may be used.

### <<Test 2>>

To determine an optimal time for which the compact is held in the decomposition temperature range, the percentage of a reduction in the weight of stearamide by heating was measured. The measurement was performed with TG-DSC. The test conditions were described below. Figure S illustrates the results.
Stearamide: granular form
Test starting temperature: 50° C.
Increase in temperature to 240° C. at 40° C./min
Holding at 240° C. for 50 min
Increase in temperature to 340° C. at 14° C./min.
Holding at 360° C. for 15 min

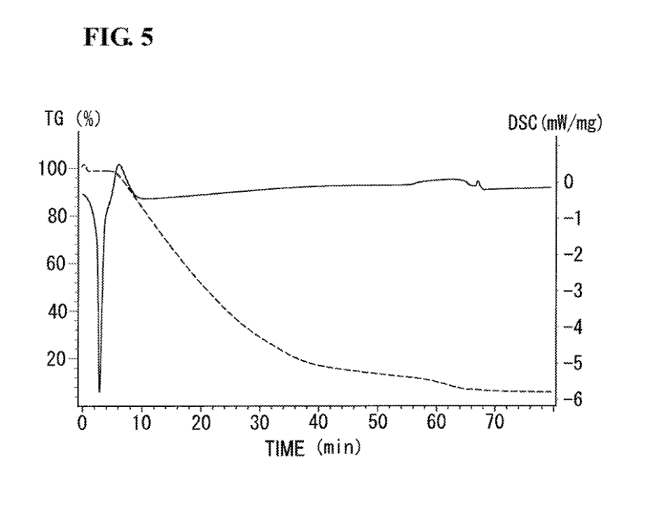

In the graph of FIG. 5, the horizontal axis represents the time (min), the left vertical axis represents the percentage (%) of the reduction in the weight of stearamide, and the right vertical axis represents the heat flow (mW/mg). In FIG. 5, the dotted line represents the percentage of the reduction in weight, and the solid line represents a change in heat flow. As illustrated in FIG. 5, for about 5 minutes from the start of the test, the value of the heat flow is negative, which indicates that stearamide is melted by an endothermic reaction. Because the weight of stearamide remains unchanged during the endothermic reaction, stearamide seems to be just melted.

After a lapse of about 5 minutes from the start of the test, the value of the heat flow is positive, which indicates that stearamide is subjected to oxidative decomposition by an exothermic reaction and starts to evaporate. The weight of stearamide continued to reduce until about 55 minutes, at which point the temperature was maintained at 240° C., and was about 14% of the original weight. In particular, after about 30 minutes from the start of the reduction in the weight of stearamide (after about 35 minutes from the start of the test), the weight of stearamide was reduced to about 24% of the original weight. Although the weight of stearamide was further reduced during an increase in temperature from 240° C. to 340° C. (55 minutes to 65 minutes), the amount of reduction was just about 5.4% of the original weight. After 65 minutes, at which point the temperature was maintained at 340° C., the weight of stearamide remains almost unchanged.

The results described above indicated that in the case of stearamide, stearamide was mostly subjected to oxidative decomposition in 30 minutes after the temperature was maintained in the decomposition temperature range, and the amount oxidatively decomposed was saturated in 50 minutes. Accordingly, it was found that the time the compact is held in the decomposition temperature range is preferably 30 minutes or more and 50 minutes or less.

### <<Test 3>>

From the results of tests 1 and 2, the oxidative decomposition temperature was determined to be 215° C.±10° C., the oxidative decomposition time was determined to be 30 minutes or more, the distortion removal temperature of the compact was determined to be 325° C.±25° C., and the distortion removal time was determined to be 20 minutes to 40 minutes. The compact was heat-treated with the carrier-type heat-treatment apparatus 1 illustrated in FIG. 2. The appearance of the dust core that has been heat-treated was visually checked for the presence of a residue on a surface of the dust core. In addition, the electrical resistance of the surface of the dust core was measured to evaluate the amount of residue.

### [Compact to be Heat-Treated]

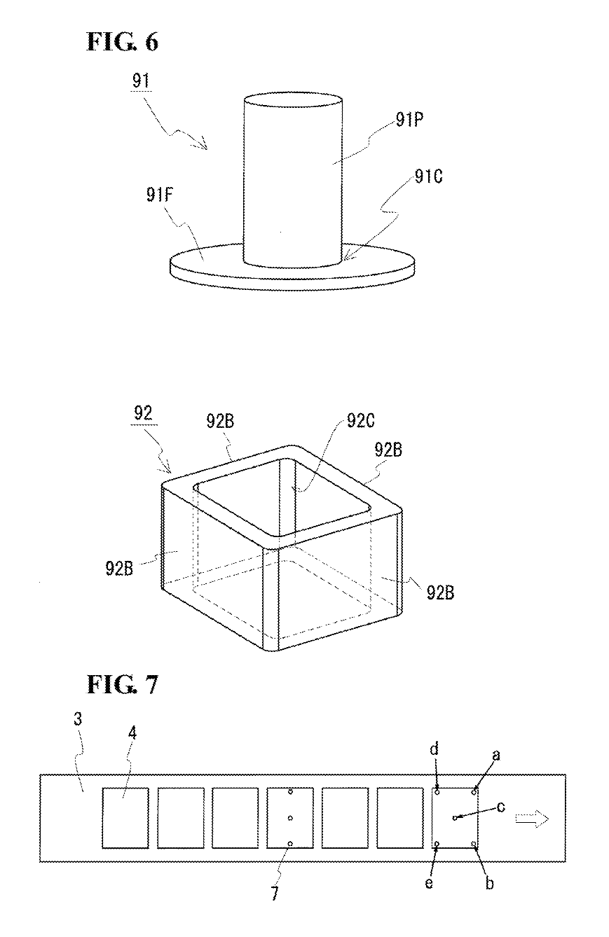

FIG. 6 illustrates compacts to be heat-treated. A compact 91 illustrated in the upper portion of FIG. 6 includes a columnar portion 91P and a flange portion 91F arranged on one end side of the columnar portion 91P. In the compact 91, a residue adheres easily to the boundary (edge portion 91C) between the columnar portion 91P and the flange portion 91F. A compact 92 illustrated in the lower portion of FIG. 6 is a compact that includes four plate-like portions 92B and that has a rectangular frame-like shape. In the compact 92, a residue adheres easily to the boundaries (edge portions 92C) between the plate-like portions 92B and 92B connected together.

### [Arrangement of Compacts in Carrier-Type Heat-Treatment Apparatus]

The arrangement of the compacts 91 and 92 are illustrated on the basis of FIG. 7 which is a top view of the mesh belt 3. In this test, as illustrated in FIG. 7, seven mesh stages 4 were aligned on the mesh belt 3, and the compacts 91 and 92 (see FIG. 6) were arranged on each of the mesh stages 4. Specifically, 195 compacts 91 having the columnar portion and the flange portion (see the upper portion of FIG. 6) were arranged with the flange portions down on the first, fourth, and seventh mesh stages 4 from the downstream end located on the right side of the paper in the transportation direction. Furthermore, 100 compacts having the rectangular frame-like shape (see the lower portion of FIG. 6) were arranged with the opening portions pointing to the transportation direction on the second, third, fifth, and sixth mesh stages 4 from the downstream end in the transportation direction. The total number of the compacts 91 and 92 arranged on the seven mesh stages 4 was about 1,000. Among the compacts arranged on the fourth mesh stage in the transportation direction, thermocouples 7 were attached to the compacts arranged on portions represented by circles in FIG. 7 to measure the temperature profile of heat treatment.

### [Heat Treatment of Compact]

The temperature of each of the heaters 21 to 27, the amount of gas injected through the gas pipe 5, and the transportation speed (operating speed of the mesh belt) of the carrier-type heat-treatment apparatus 1 illustrated in FIG. 2 were set in such a manner that the compacts 91 and 92 transported by the mesh belt 3 were subjected to heat treatment at 215° C.±10° C. for 30 minutes and then heat treatment at 325° C.±25° C. for 20 minutes or more and 40 minutes or less.

The compacts 91 and 92 (see FIG. 6) were heat-treated with the carrier-type heat-treatment apparatus 1 (see FIG. 2) on which the setting were made as described above while the measurement results of the thermocouples 7 (see FIG. 7) attached to the compacts were monitored. Three thermocouples 7 indicated substantially the same measurement result. This demonstrated that the heat treatment was performed in the width direction of the mesh belt 3 without variations. From the monitoring results, the compacts were heated to about 215° C.±10° C. in the zone Z1 illustrated in FIG. 2 and maintained at 215° C.±10° C. in the zones Z2 to Z4. The compacts were heated to 325° C.±25° C. in the zone Z5 and maintained at 325° C.±25° C. in the zones Z6 and the almost end portion of the zone Z7. The passage time from the zone Z2 to the zone Z4 was about 30 minutes. In other words, the heat-treatment time of the compacts at 215° C. was about 30 minutes. The heat-treatment time of the compacts from the zone Z6 to the zone Z7 was about 30 minutes.

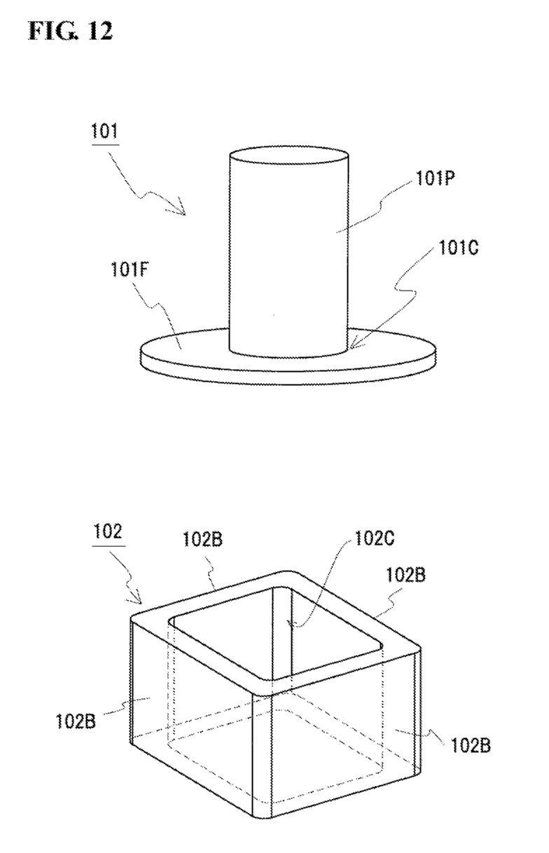

With regard to dust cores 101 and 102 (see FIG. 12) that had been heat-treated, all peripheral surfaces of the dust cores 101 and 102 were visually checked for the adhesion of a residue. In particular, edge portions 101C and 102C, to which a residue adheres easily, were checked for the adhesion of a residue. The residue has a clearly different color from the oxide coatings of the dust cores 101 and 102. If the residue adheres to a surface of each of the dust cores 101 and 102, the residue can be easily and visually identified. The results indicated that defective products (dust cores having the edge portions 101C and 102C to which the residues adhered) were found as follows: when viewed from the transportation direction, three defective products were found on the second mesh stage 4 (see FIG. 7), two defective products were found on the third mesh stage 4, one defective product was found on the fourth mesh stage 4, and one defective product was found on the seventh mesh stage 4. About 1,000 compacts 91 and 92 were heat-treated; thus, the incidence of the defective products due to the method for heat-treating the compacts 91 and 92 was only about 0.7%.

The dust cores 101 and 102 were sampled from each of the mesh stages 4. The electrical resistance (μΩ·m) and the amount of C (carbon) on the surface of each of the dust cores 101 and 102. As illustrated in FIG. 7, a total of five sampling sites were used: the front left end, which is represented by the lower-case alphabetic character “a”, in the transportation direction; the front right end, which is represented by the lower-case alphabetic character “b”, in the transportation direction; the center represented by “c”; the rear left end represented by “d” in the transportation direction; and the rear right end represented by “e” in the transportation direction. The electrical resistance was measured by a four-point probe method, and the amount of surface C was measured by EDX (acceleration voltage: 15 kV).

The electrical resistance is an index to confirm that the oxide coatings are uniformly arranged on the surfaces of the dust cores 101 and 102. In this test example, in the case of an electrical resistance of 100 μΩ·m or more, it is determined that the oxide coatings are uniformly arranged on the surfaces of the dust cores.

The amount of surface C is an index to confirm that no residue adheres to the surfaces of the dust cores 101 and 102 and the percentage of C in the total amount of atoms detected in the analysis of constituent elements on the surfaces. A residue formed by carbonization of stearamide is mainly composed of C (carbon). If the residue adheres to the surfaces of the dust cores 101 and 102, C is detected on the surfaces of the dust cores 101 and 102. In this test example, in the case where the amount of surface C of each dust core is 50 at % (atomic percent) or less, it is determined that no residue adheres to the surface of the dust core.

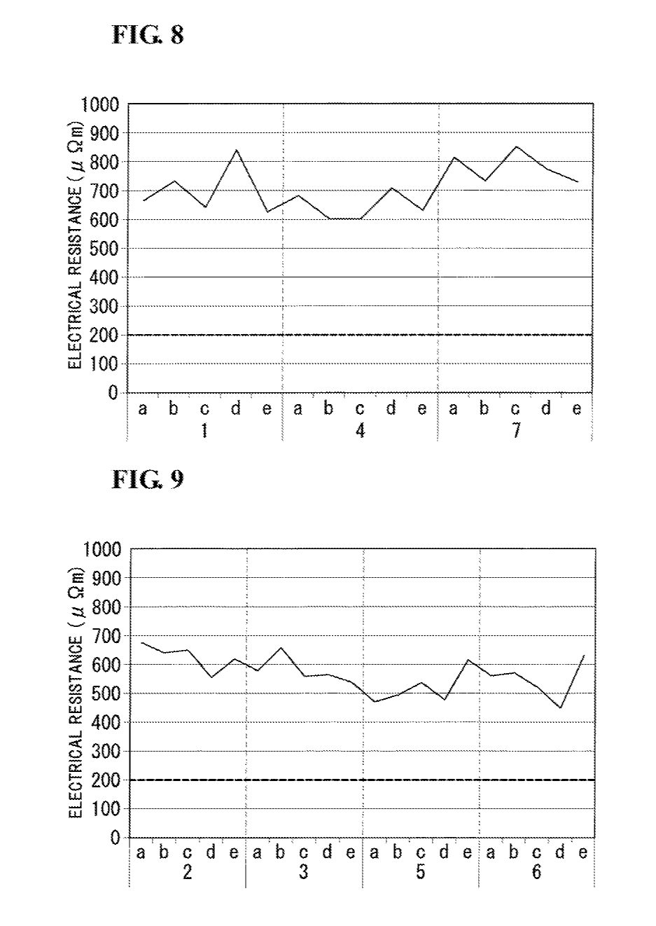

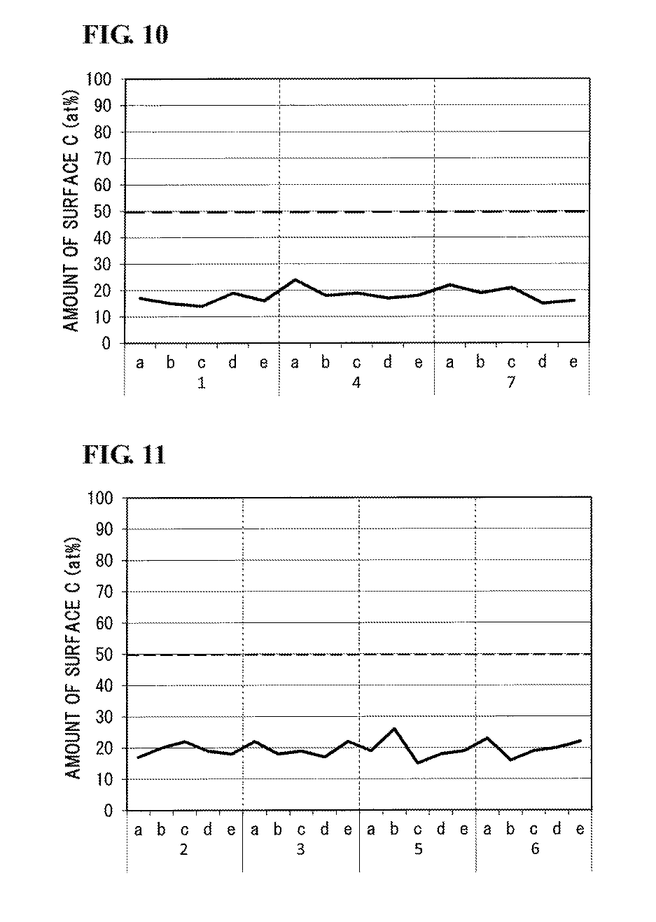

FIGS. 8 and 10 are graphs illustrating the sampling results of the dust cores 101 having the flange portion (see the upper portion of FIG. 12). FIGS. 9 and 11 are graphs illustrating the sampling results of the dust cores 102 having the rectangular frame-like shape (see the lower portion of FIG. 12). In each of FIGS. 8 and 9, the horizontal axis of the graph represents the sample number, and the vertical axis represents the electrical resistance of each sample. In each of FIGS. 10 and 11, the horizontal axis of the graph represents the sample number, and the vertical axis represents the amount surface C of each sample. In these graphs, the numerals located in the lower portion of the sample number are numbers of the mesh stages 4 illustrated in FIG. 7 when viewed from the transportation direction, and the lower-case alphabetic characters located in the upper portion represent the sampling sites.

Each of the dust cores 101 having the flange portion illustrated in FIG. 8 had an electrical resistance of 600 μΩ·m or more. Each of the dust cores 102 having the rectangular frame-like shape illustrated in FIG. 9 had an electrical resistance of 250 μΩ·m or more. That is, the electrical resistance of each of the dust cores 101 and 102 sampled was 100 μΩ·m or more. This indicated that the oxide coatings were uniformly arranged on the surfaces of the dust cores 101 and 102.

The amount of surface C on the edge portion 101C, at which a residue was easily formed, of each of the dust cores 101 having the flange portion illustrated in FIG. 10 was 30 at % or less. The amount of surface C on each of the edge portions 102C, at which a residue was easily formed, of the dust cores 102 having the rectangular frame-like shape illustrated in FIG. 11 was 30 at % or less. That is, the amount of surface C of each of the dust cores 101 and 102 sampled was 50 at % or less. This indicated that no residue adhered to the surface of the dust core 101 or 102.

### <<Summary of Tests 1 to 3>>

Tests 1 to 3 revealed that the heat-treating method for compact according to the embodiment is suitable for the production of the dust core having a surface to which no residue adheres.

### <<Test 4>>

In test 4, sample I subjected to the two-stage heat treatment with the carrier-type heat-treatment apparatus 1 illustrated in FIG. 2 and sample II subjected to a single-stage heat treatment with a conventional carrier-type heat-treatment apparatus were produced. The DC magnetization characteristics (maximum relative magnetic permeability μₘ) and the transverse rupture strength (MPa) of each of samples I and II were measured.

The first-stage heat treatment for sample I was performed at 215° C.±10° C. for 1.5 hours, and the second-stage heat treatment was performed 525° C.±25° C. for 15 minutes. The heat treatment for sample II was performed at 525° C.±25° C. for 15 minutes. For both samples I and II, the rate of temperature increase was 5° C./min. and the heat-treatment atmosphere was air.

Samples I and II were subjected to an evaluation test of the DC magnetization characteristics according to JIS C 2560-2. The DC magnetization characteristics were evaluated with measurement components in which test pieces having a ring-like shape with an outside diameter of 34 mm, an inside diameter of 20 mm, and a thickness of 5 mm each had 300 turns of the primary winding and 20 turns of the secondary winding.

The results of the evaluation test indicated that sample I had a maximum relative magnetic permeability μₘ of 605 and sample II had a maximum relative magnetic permeability μₘ of 543. That is, the maximum relative magnetic permeability μₘ of sample I subjected to the two-stage heat treatment was about 1.1 times that of sample II subjected to the single-stage heat treatment.

Samples I and II were subjected to an evaluation test of transverse rupture strength (three-point flexural test) according to JMS Z 2511. Rectangular plate-shaped test pieces measuring 55 mm×10 mm×10 mm were used for the evaluation of the transverse rupture strength. The results of the flexural test indicated that sample I had a transverse rupture strength of 74.1 MPa and sample II had a transverse rupture strength of 41.1 MPa. That is, the transverse rupture strength of sample I subjected to the two-stage heat treatment was about 1.8 times that of sample II subjected to the single-stage heat treatment.

The difference between the methods for producing samples I and II is whether the two-stage heat treatment is performed or not. The reason sample I had better characteristics than sample II is presumably that almost all the compacting assistant was removed from the inside of the compact through the first-stage heat treatment.

### INDUSTRIAL APPLICABILITY

The heat-treating method for compact according to the present invention is suitably employed in heat-treating dust cores that can be used as magnetic cores of various coil components (for example, reactors, transformers, motors, choke coils, antennas, fuel injectors, and ignition coils (sparking coils)) and materials thereof.

### REFERENCE SIGNS LIST

1 carrier-type heat-treatment apparatus
2 furnace main body 21 to 27 heater 2E exterior 2M muffle
3 mesh belt
4 mesh stage
5 gas pipe
6 heat insulator
7 thermocouple
Z1 to Z7 zone
9, 91, 92 compact
91P columnar portion 91F flange portion 91C edge portion
92B plate-like portion 92C edge portion
101, 102 dust core
101P columnar portion 101F flange portion 101C edge portion
102B plate-like portion 102C edge portion

1. A heat-treating method for compact, comprising:
a compacting step of forming a compact by compacting a soft magnetic powder together with a compacting assistant, the soft magnetic powder being a collection of coated particles that are soft magnetic metal particles having a surface coated with an insulation coating; and
a heat-treatment step of heat-treating the compact,
the heat-treatment step including a first heat-treatment substep of performing heat treatment at a temperature in a decomposition temperature range of the compacting assistant, and
a second heat-treatment substep of performing heat treatment at a temperature at which distortion of the soft magnetic powder in the compact is removed and which is higher than the temperature of the first heat treatment.

2. A dust core including a soft magnetic powder that is a collection of coated particles that are soft magnetic metal particles having a surface coated with an insulation coating, comprising:
an oxide coating formed on all peripheral surfaces of the dust core by heat treatment,
wherein substantially no residue formed by carbonization of a compacting assistant adheres to a surface of the dust core.

3. The dust core according to claim 2, further comprising an edge portion.

4. The dust core according to claim 3, further comprising a columnar portion and a flange portion arranged on one end side of the columnar portion.
